(19) United States
(12) Patent Application Publication
(10) Pub. No.: US 2014/0257958 A1
(43) Pub. Date: Sep. 11, 2014

(54) MERCHANT INCENTIVE PROGRAMS ON PROXY CARD SYSTEMS

(71) Applicant: Google Inc., Mountain View, CA (US)

(72) Inventor: Mark William Andrews, San Francisco, CA (US)

(73) Assignee: Google Inc., Mountain View, CA (US)

(21) Appl. No.: 13/786,055

(22) Filed: Mar. 5, 2013

(51) Int. Cl. G06Q 30/02

(52) U.S. Cl. CPC G06Q 30/0226
USPC 705/14.27

(57) ABSTRACT

Selecting an alternate payment instrument after a proxy card payment transaction comprises associating the proxy card account comprising with a plurality of financial accounts that can be selected for funding financial transactions; associating a merchant account with a merchant, the merchant account comprising an incentive program; associating the user proxy card account with the incentive program; receiving a payment authorization request; accessing the user proxy card account based on the identification of the user proxy card account; determining that the user proxy card account is associated with the merchant's incentive program; when the item information in the transaction data meets at least one rule in the set of rules for obtaining the incentive, applying the incentive to the user proxy account associated with the merchant's incentive program; and communicating a notification of the applied incentive to a user associated with the user proxy card account.

### TECHNICAL FIELD

The present disclosure relates generally to proxy card payment systems, and more particularly to managing merchant incentive programs on proxy card payment processing systems.

### BACKGROUND

Managing incentive programs can be time consuming and expensive for smaller merchant systems. A merchant system may wish to reward loyal customers, attract new customers, provide programs that encourage additional sales, or offer other incentive programs. For example, a merchant system may want to offer a loyalty program that offers loyalty points to customers for purchases or for performing other instances of loyalty. The merchant system may want to offer a stored value account for users to make purchase transactions quicker and easier and also may want to provide rebates, coupons, discounts, or other incentives to loyal users.

These loyalty programs and stored value programs can cost more time and funds than a small or medium merchant system may be able to provide. For example, to operate an incentive program, the merchant system may need to provide loyalty cards or stored value cards to users. The cards must be purchased, configured, and managed by the merchant system. In another example, the merchant system must provide a system to manage the accounts of the users. The merchant system must provide a server or other computing system to manage the accounts and record transaction data, or the merchant system must provide labor to conduct a manual system.

Conventional incentive programs do not allow a merchant system to provide incentive programs utilizing existing payment processing systems associated with user proxy cards.

### SUMMARY

One aspect of the example embodiments described herein provides a computer-implemented method to maintain incentive programs on proxy card payment processing systems. The method comprises associating, using one or more computer devices, a proxy card account with a plurality of financial accounts that can be selected for funding financial transactions; associating a merchant account with a merchant, the merchant account comprising an incentive program comprising a set of rules for obtaining an incentive in connection with a purchase transaction; associating the user proxy card account with the incentive program; receiving a payment authorization request comprising transaction data from a merchant computing device operated by the merchant, the transaction data comprising an identification of the user proxy card account for funding of the transaction and information for at least one item involved in a purchase transaction with the merchant; accessing the user proxy card account based on the identification of the user proxy card account received in the transaction data; determining that the user proxy card account is associated with the merchant's incentive program; determining whether the item information in the transaction data meets at least one rule in the set of rules for obtaining the incentive, in response to determining that the user proxy card account is associated with the merchant's incentive program; when the item information in the transaction data meets at least one rule in the set of rules for obtaining the incentive, applying the incentive to the user proxy account associated with the merchant's incentive program; and communicating a notification of the applied incentive to a user associated with the user proxy card account.

A computer program product that is installed on a server located in a payment system to maintain incentive programs on proxy card payment processing systems. The computer program product includes a non-transitory computer-readable storage device having computer-readable program instructions stored therein. The computer-readable program instructions include computer program instructions for associating a user proxy card account with a user; associating the proxy card account comprising with a plurality of financial accounts that can be selected for funding financial transactions; associating a merchant account with a merchant, the merchant account comprising an incentive program comprising a set of rules for obtaining an incentive in connection with a purchase transaction; associating the user proxy card account with the incentive program; receiving a payment authorization request comprising transaction data from a merchant computing device operated by the merchant, the transaction data comprising an identification of the user proxy card account for funding of the transaction and information for at least one item involved in a purchase transaction with the merchant; accessing the user proxy card account based on the identification of the user proxy card account received in the transaction data; determining that the user proxy card account is associated with the merchant's incentive program; determining whether the item information in the transaction data meets at least one rule in the set of rules for obtaining the incentive, in response to determining that the user proxy card account is associated with the merchant's incentive program; when the item information in the transaction data meets at least one rule in the set of rules for obtaining the incentive, applying the incentive to the user proxy account associated with the merchant's incentive program; and communicating a notification of the applied incentive to a user associated with the user proxy card account.

These and other aspects, objects, features and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system to manage merchant incentive programs on proxy card payment processing systems, in accordance with certain example embodiments.

FIG. 2 is a block flow diagram depicting a method to manage merchant incentive programs on proxy card payment processing systems, in accordance with certain example embodiments.

FIG. 3 is a block flow diagram depicting a method to access and update a user incentive account when a user conducts a transaction using a proxy card, in accordance with certain example embodiments.

FIG. 4 is a block diagram depicting a computing machine and a module, in accordance with certain example embodiments.

### DETAILED DESCRIPTION OF THE EXAMPLE EMBODIMENTS

### Overview

In an example embodiment, a merchant system can register an incentive program with a payment processing system. The payment processing system can be associated with a proxy card used by customer of the merchant system. The payment processing system can manage the incentive program for the merchant system.

When a user conducts a transaction with the merchant system using a proxy card associated with the payment processing system, the payment processing system accesses the accounts of the user and the merchant system. If the merchant system has an incentive program being managed by the payment processing system and the user has an incentive account on the incentive program, then the payment processing system can take appropriate action. For example, the payment processing system can record loyalty points for qualifying purchases in the user account, the payment processing system can deposit rebates into a stored value account of the user, or the payment processing system can provide any incentives configured by the merchant system.

In one example embodiment, payment processing systems enable users to utilize a single card to access multiple financial accounts maintained by multiple issuers. The user receives a proxy card from the payment processing system and either creates a new proxy card account with the payment processing system or associates the proxy card with the user's digital wallet account already maintained by the payment processing system.

The user then associates one or more financial card accounts with the proxy account. For example, the user can associate with the user's proxy card account multiple debit/credit cards maintained by multiple issuers (including the payment processing system operating as an issuer), stored value cards (for example, gift cards, prepaid cards, re-loadable transaction cards, exchange cards, and other forms of non-credit based value cards), loyalty cards or other store rewards cards, value added service accounts (for example, coupons, vouchers for prepaid offers, redemption offers, and other forms of offers), peer-to-peer transaction accounts, bank accounts and/or other forms of financial accounts.

The proxy card can be represented on a digital wallet application module or other payment application on a user computing device, such as a mobile phone. For example, the user proxy card account information, such as a proxy card account identifier, can be stored on the user computing device for use in a payment transaction by the digital wallet application module or other application. The user can communicate the proxy card account identifier and other transaction data to a merchant point of sale (“POS”) terminal using the user computing device via near filed communication, BLUETOOTH, barcode, Wi-Fi communication, infrared, or any other suitable communication technology. Alternatively, the proxy card can be or include a physical payment card comprising a magnetic stripe or other machine-readable portion comprising the user's proxy card account identifier and other payment information. In this case, the user scans or swipes the proxy card at the merchant POS terminal to communicate the proxy card account identifier and other transaction data to the merchant POS terminal. Additionally or alternatively, the proxy card can be represented using any other suitable payment instrument, such as an RFID device or a smartcard. Additionally or alternatively, the payment instrument can be a digital wallet or other payment instrument on a user computing device for conducting online transactions, such as a mobile or desktop computer, laptop computer, or a television with one or more processors embedded therein and/or coupled thereto.

The merchant system creates a payment request for the transaction using the proxy card information and forwards the payment request to an acquirer, which forwards the payment request to a card network. The card network forwards the payment request to the payment processing system, which functions as the issuer for the payment request.

The payment processing system reads proxy card account information from the payment request and accesses the user's account associated with the proxy card. If the payment processing system is the issuer of the particular financial account selected as the backing instrument for the proxy card transaction, the payment processing system will approve or decline the transaction.

If another issuer maintains the particular financial account to be used as the backing instrument for the transaction, the payment processing system will generate and send a new payment request for the transaction to the other issuer via the card network (or via different card network). The payment processing system receives an authorization message from the other issuer via the card network if the transaction is approved.

The payment processing system forwards an authorization to the acquirer through the card network, which forwards the authorization to the merchant system. The authorization is based on the payment processing system's determination as the issuer to authorize the transaction or the authorization received from the other issuer.

The merchant system then approves the transaction, based on the authorization received from the payment processing system.

The user sets rules or preferences specifying which financial account will be accessed and used as the backing instrument when a proxy card transaction is attempted. The user can then add, delete, or change the default payment rules associated with the user's proxy card account. The user can change these default static rules, create new rules, or delete a rule. In an example embodiment, the user can access the proxy card account and modify the rules at any time, including a time immediately before a payment transaction is initiated. In an example embodiment, the user can access the proxy card account using a mobile device application, such as a digital wallet application module executing on the user's mobile computing device. The rules can be maintained on the digital wallet application module, on the user device, or on a server at the payment processing system. Throughout the specification, any of the functions described as being performed by the digital wallet application module or the user computing device can be performed by the payment processing system. Alternatively, any functions described as being performed by the payment processing system can be performed by the digital wallet application module or the user computing device.

In an example embodiment, a merchant system registers for a merchant system incentive account at the payment processing system. The merchant system can configure a loyalty rewards program, a stored value program, or any other incentive program. The merchant system can establish rules for the programs, such as registration requirements, eligibility requirements, reward rules, and other suitable rules. Additionally, the merchant system can establish reporting rules for logging usage of the incentive programs. The merchant system can use the logged usage to track performance of the programs, modify programs, and find preferred customers.

The user can establish an incentive account with the payment processing system. If the user has previously established a proxy card account with the payment processing system, then the user can associate the proxy card account with an incentive program from the merchant system. For example, the user can scroll through a list of incentive programs and merchant systems offering incentive programs and select a program to join. Alternatively, the user can search for a program with a keyword search or other program searching technique. Alternatively, the user can access the incentive program by scanning a code at the merchant system, following a link on the Internet, or via any other suitable method. The user can select the incentive program and associate the program with the user proxy card account managed by the payment processing system.

The user can select a product of a merchant system for purchase. Throughout the specification, the term “product” can refer to tangible and intangible products as well as services. The user initiates a transaction with the merchant POS terminal. The user can “tap” or swipe a user computing device to initiate the communication with the POS terminal, actuate a real or virtual button, speak a voice command, or in any suitable manner initiate the transaction. The digital wallet application module on the user device can transmit the proxy card identification to the POS terminal. Alternatively, the user can employ any other device to initiate the transaction, such as a magnetic stripe card, a smartcard, an RFID device, or any other suitable device. In an alternate example embodiment, the transaction is an online transaction and the user can input the proxy card information or employ a digital wallet application module on the user computing device.

The merchant system recognizes that a proxy card is being utilized for the transaction and transmits the transaction data to the payment processing system. In alternate example embodiments, the merchant system transmits the transaction data to the card network and the card network recognizes that a proxy card is being utilized. The recognition of a proxy card transaction can be made at any point in the transaction or after the transaction, and by any party involved in the transaction process. Alternatively, the parties involved in routing the transaction may view the proxy card payment information as a typical payment method, such as a credit card payment. An identifier in the proxy card payment information instructs the transaction parties to route the proxy card payment information to the payment processing system for processing of the transaction.

When the payment processing system receives the transaction data from the merchant system, the payment processing system determines if the merchant system has a merchant account on the payment processing system and has established one or more incentive programs. If the merchant system has established an incentive program, the payment processing system determines if the user has an account in one or more of the incentive programs associated with the user's proxy card account. The payment processing system can extract the proxy card number of the user and can compare the proxy card number to a database containing the incentive programs. The payment processing system can identify the incentive programs in which the user is participating.

The payment processing system can compare the transaction data to the incentive rules and parameters for the incentive program. The payment processing system determines whether the transaction qualifies for an incentive program configured by the merchant system and joined by the user.

In an example embodiment, the incentive program is a loyalty rewards program. In a loyalty rewards program, the payment processing system can determine that one or more of the purchased products, or the entire transaction, meets the requirements to receive a reward, loyalty points, a discount, or any other loyalty incentive. For example, the payment processing system can determine that the user has met the requirements of a “buy 3, get 1 free” incentive. In another example, the payment processing system can determine that the transaction is the tenth transaction by the user during a specified time period and a discount is due for the transaction. In another example, the user has purchased a product in a certain category and thus rewards points are due to the loyalty account of the user.

In another example embodiment, the incentive program is a stored value account. The user has established the stored value account and associated the stored value account with the proxy card account of the user. The stored value account contains funds that can be used for transactions at the merchant system associated with the stored value account. The funds can be deposited in the stored value account by the user, by the merchant system, or any suitable party.

When a user conducts a transaction with the merchant system associated with the stored value account, the payment processing system can use the funds in the stored value account to fund some or all of the transaction. The payment processing system can automatically use the stored value funds, offer to the user an option to use the stored value fund, or follow any other rules or guidelines for using the stored value funds.

Additionally or alternatively, the stored value account can be configured as one of the backing instruments for the proxy card account. The stored value account can be used in any transactions, may be limited to transactions with the merchant system associated with the stored value account, or can be limited according to any suitable set of rules or restrictions.

Additionally or alternatively, the stored value account can receive rewards supplied by the merchant system, the payment processing system, or any suitable party. For example, if the user is due a reward for a qualifying purchase, the reward can be in the form of funds deposited into the stored value account of the user.

The payment processing system can report the use of the incentive program to the merchant system and/or the user. For example, the payment processing system can supply a report to the merchant system that indicates the rewards earned by users. The report can show individual users or groups of users. The report can categorize users and indicate trends and usage rates for different categories of users. The report can indicate the total costs of incentive programs over any period of time. The report can allow the merchant system to better modify the incentive programs to limit costs or produce different results. The report can allow a merchant system to see the activity of a user to determine factors such as frequency of transactions, total value of transactions, date of most recent transaction, and other suitable data. The payment processing system can supply the report to the merchant system or the merchant system can access the data on a server or website of the payment processing system. The merchant system can sort and analyze the data from the payment processing system to improve the incentive programs or to better achieve desired goals.

The merchant system or the payment processing system can report the use of the incentive program to the user. The data can indicate to the user the reward level attained, usage required to obtain the next reward level, the available funds in the stored value account, transaction history with the merchant system, view new incentives available, and other suitable data. The user can utilize the incentive program data to better manage future transactions with the merchant system or for any suitable purposes.

### Example System Architectures

Turning now to the drawings, in which like numerals represent like (but not necessarily identical) elements throughout the figures, example embodiments are described in detail.

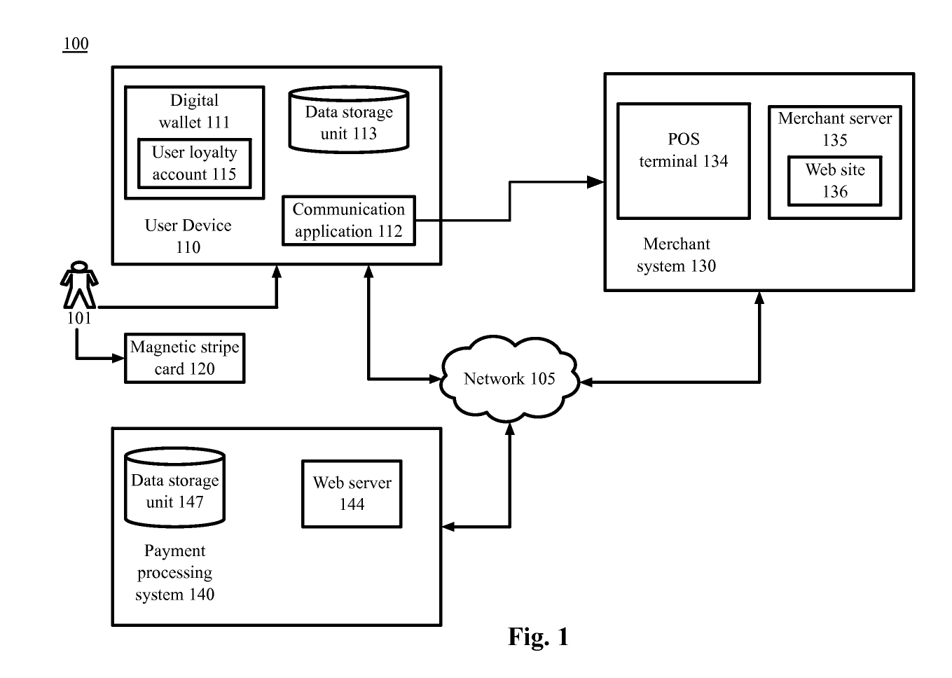

FIG. 1 is a block diagram depicting a system to manage merchant incentive programs on proxy card payment processing systems, in accordance with certain example embodiments. As depicted in FIG. 1, the system 100 includes network devices 110, 130, and 140 that are configured to communicate with one another via one or more networks 105.

Each network 105 includes a wired or wireless telecommunication means by which network devices (including devices 110, 130, and 140) can exchange data. For example, each network 105 can include a local area network (“LAN”), a wide area network (“WAN”), an intranet, an Internet, a mobile telephone network, or any combination thereof. Throughout the discussion of example embodiments, it should be understood that the terms “data” and “information” are used interchangeably herein to refer to text, images, audio, video, or any other form of information that can exist in a computer-based environment.

Each network device 110, 130, and 140 includes a device having a communication module capable of transmitting and receiving data over the network 105. For example, each network device 110, 130, and 140 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network devices 110, 130, and 140 are operated by end-users or consumers, merchant system operators, and payment processing system operators, respectively.

The user 101 can use the communication application 112, which may be, for example, a web browser application or a stand-alone application, to view, download, upload, or otherwise access documents or web pages via a distributed network 105. The network 105 includes a wired or wireless telecommunication system or device by which network devices (including devices 110, 130, and 140) can exchange data. For example, the network 105 can include a local area network (“LAN”), a wide area network (“WAN”), an intranet, an Internet, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data, and/or messages.

The communication application 112 can interact with web servers or other computing devices connected to the network 105, including the point of sale terminal 134 of the merchant system 130, the merchant server 135 of the merchant system 130, and the web server 144 of the payment system 140.

The user network device 110 may include a digital wallet application module 111. The digital wallet application module 111 may encompass any application, hardware, software, or process the user device 110 may employ to assist the user 101 in completing a purchase. The digital wallet application module 111 can interact with the communication application 112 or can be embodied as a companion application of the communication application 112. As a companion application, the digital wallet application module 111 executes within the communication application 112. That is, the digital wallet application module 111 may be an application program embedded in the communication application 112.

The user device 110 can include a user loyalty application 115. The user loyalty application 115 can interact with the communication application 112 or be embodied as a companion application of the communication application 112 and execute within the communication application 112. The user loyalty 115 may further be embodied as a companion application of the digital wallet application module 111 and execute within the digital wallet application module 111. The user loyalty application 115 may employ a software interface for configuration that may open in the digital wallet application module 111 or may open in the web browser application 112. Alternatively, the user loyalty application 115 may be execute on the user device 110 independent of the digital wallet application module 111 and the communication application 112.

The user loyalty application 115 is operable to allow a user 101 to configure a user loyalty account on the user device 110 and the payment processing system 140. The user loyalty application 115 can allow the user 101 to set rules, confirm transactions, select preferred incentives, receive notice of a incentives earned, and provide other suitable services. Any functions of the user loyalty application 115 can be performed by the digital wallet application 111 or the merchant loyalty application 142.

The user device 110 also includes a data storage unit 113 accessible by the digital wallet application module 111, the user loyalty application 115, and the communication application 112. The example data storage unit 113 can include one or more tangible computer-readable storage devices. The data storage unit 113 can be stored on the user device 110 or can be logically coupled to the user device 110. For example, the data storage unit 113 can include on-board flash memory and/or one or more removable memory cards or removable flash memory.

The user 101 may use the user device 110 or other network device to register the user loyalty application 115 and/or access the payment system account or the loyalty account of the user 101. The user device 110 may comprise appropriate technology that includes or is coupled to a web server.

The proxy card or other payment instrument can be a magnetic strip, smart, or integrated circuit card 120. The discussion below primarily uses a magnetic strip card 120 as the example, but the techniques herein apply equally to smart cards 120 and integrated circuit cards 120. The magnetic stripe card 120 can be a physical payment card comprising a magnetic stripe or other machine-readable portion comprising the user's proxy card account identifier and other payment information. In this case, the user 101 scans or swipes the magnetic stripe card 120 at the merchant POS terminal 134 to communicate the proxy card account identifier and other transaction data to the POS terminal 134. Additionally or alternatively, the magnetic stripe card 120 can be any other suitable payment instrument, such as an RFID device or a smartcard.

The payment processing system 140 is utilized to manage a payment account of the user 101 such as a proxy card account. The payment processing system 140 includes a data storage unit 147 accessible by the web server 144. The example data storage unit 147 can include one or more tangible computer-readable storage devices. The payment processing system 140 is operable to conduct contactless payments between a user 101 and a merchant system 130. The payment system 140 is further operable to maintain a database to store transactions of the merchant system 130 and the user 101, and other suitable functions.

The user 101 can use a web server 144 on the payment processing system 140 to view, register, download, upload, or otherwise access the payment processing system 140 via a website (not illustrated) and a communication network 105). The user 101 associates one or more registered financial card accounts, including bank account debit cards, credit cards, gift cards, loyalty cards, coupons, offers, prepaid offers, store rewards cards, or other type of financial account that can be used to make a purchase or redeem value-added services with a payment account of the user 101. The payment processing system 140 also may function as the issuer for the associated financial account. The user's 101 registration information is saved in the payment system's 140 data storage unit 147 and is accessible the by web server 144.

The merchant system 130 may use a web server 135 to view, download, upload, create incentive programs, create offers, sell products online, or otherwise access the payment processing system 140 via a website 136 and a communication network 105. The merchant system 130 represents an entity that offers products for the user 101 to purchase or use. The merchant system 130 includes a POS terminal 134. The POS terminal 134 may be operated by a salesperson that enters the purchase data into the POS terminal 134 to complete the purchase transaction. The merchant system 130 may be a physical location or an online merchant.

The user 101 may request a purchase from the merchant system 130. In an example embodiment, the purchase is initiated by a wireless “tap” of the mobile device 110 with the POS terminal 134. In an alternative example embodiment, the purchase is initiated when the user 101 enters an account identification number at the POS terminal 134 or in the mobile device 110. In another alternative example embodiment, the purchase is initiated online with the merchant server 135. The purchase may be initiated via the merchant website 136. In yet another alternative example embodiment, the purchase is initiated by use of a permanent/temporary virtual/physical token, QR code, bar code, or other suitable machine-readable medium captured by the POS terminal 134. The merchant's POS terminal 134 interacts with an acquirer, the card network, the payment system 140, and the issuer. In another example, the purchase is conducted in an online environment. The user device 110 can interact with the merchant system 130 over the Internet via the network 105 or any other online manner. The user 101 can make online purchases and conduct online transitions with the merchant system 130.

### Example Processes

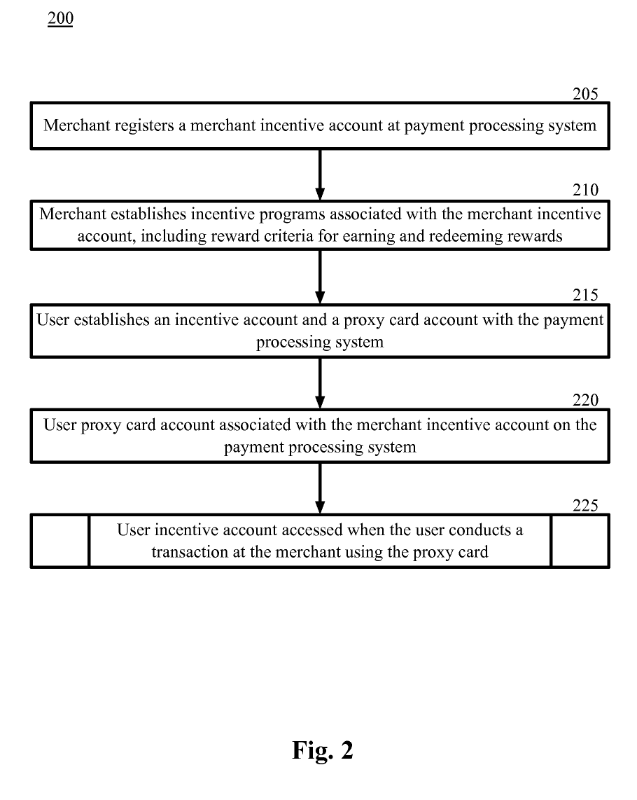

The components of the example operating environment 100 are described hereinafter with reference to the example methods illustrated in FIG. 2.

FIG. 2 is a block flow diagram depicting a method 200 to manage merchant incentive programs on proxy card payment processing systems, in accordance with certain example embodiments.

With reference to FIGS. 1 and 2, in block 205 a merchant system 130 registers for a merchant incentive account at the payment processing system 140. The merchant incentive account can be used by the payment processing account 140 to identify a merchant system 140 in a proxy card transaction. When the payment processing system 140 identifies a merchant system 130 in a transaction, the payment processing system 140 can search for incentive programs associated with the merchant system 130. The merchant system 130 can register for a merchant incentive account by accessing the payment processing system server 144 over the network 105.

In block 210, the merchant system 130 can configure a loyalty rewards program, a stored value program, or any other incentive program. The merchant system 130 can establish rules for the programs, such as registration requirements, eligibility requirements, reward rules, and other suitable rules. For example, a rule may include the dates that the incentive program is in effect, a list of products that are eligible for an incentive, a total amount to be transacted to receive a rebate, or any suitable rule. Additionally, the merchant system 130 can establish reporting rules for logging usage of the incentive programs. The merchant system 130 can use the logged usage to monitor performance of the programs, modify programs, and find preferred customers. The merchant system 130 can configure the incentive program by accessing the payment processing system server 144 over the network 105.

In block 215, the user 101 establishes an incentive account and a proxy card account with the payment processing system 140. The user 101 accesses the payment processing system server 144 with the user device 110 over the network and establishes the incentive account. The user 101 alternatively employs the user loyalty application 115 or the digital wallet application module 111 on the user device 110 to establish an incentive account and a proxy card account.

The payment processing system 140 issues a proxy card account to the user 101. In an example embodiment, the user 101 requests a proxy card using a web server 144, and the proxy card is mailed to the user 101. The user 101 may be issued an account number to be used for transactions via the Internet before or after a physical card is received. In an alternative example embodiment, the payment processing system 140 mails an inactivated proxy card to the user 101. The proxy card is then activated by the user 101 before use. In an alternative example embodiment, a physical proxy card is not issued. The proxy card account information can be stored in the user device 110 and is used to make a payment via a NFC, Bluetooth, barcode Wi-Fi, or other form of wireless tap of the user device 110 with the point of sale (“POS”) terminal 134. In an alternative example embodiment, the purchase is initiated when the user 101 enters an account identification number at the POS terminal 134 or in the user device 110. The account identification number may be the proxy card account number or a different number that links the payment transaction to the proxy card account. In yet another alternative example embodiment, a purchase is initiated by use of a permanent/temporary virtual/physical token QR code, bar code, or other suitable machine-readable medium that is read by the POS terminal 134. In these cases, the POS terminal 134 may comprise a scanner, camera, or other reading device that captures the proxy account information, such as a bar code or QR reader or other suitable reading device. The proxy account information may be printed in paper or other form.

The user 101 creates a new payment processing system 140 account or links the proxy card to an existing account on the payment processing system 140. The payment processing system 140 also may create or update an account on a digital wallet application module 111 on the user device 110. All functions throughout the specification described as being performed by the digital wallet application module 111 may be performed by the user loyalty application 115.

The user 101 activates the proxy card and associates one or more financial instrument accounts (for example, debit cards, credit cards, gift cards/stored value cards, loyalty cards/reward cards, peer-to-peer payment accounts, coupons, prepaid or other offers, and other accounts used to make a purchase or redeem value added services) with the proxy card account. In an example embodiment, the user 101 associates multiple financial instrument accounts with the proxy card account. The user 101 may perform this block by inputting identifying information for each financial payment instrument account.

In an example embodiment, one or more financial instrument account(s) are maintained by the payment processing system 140 and other payment instrument systems. In an alternative example embodiment, the payment processing system 140 maintains one or more of the financial instrument accounts and acts as the issuer for that financial instrument account. In another example embodiment, the financial instrument accounts are maintained by more than one payment instrument systems, including the payment processing system 140.

In block 220, if the user 101 has previously established a proxy card account with the payment processing system 140, then the user 101 can associate the proxy card account with an incentive program from the merchant system 130. For example, the user 101 can scroll through a list of incentive programs and merchant systems 130 offering incentive programs and select a program to join. Alternatively, the user 101 can search for a program with a keyword search or other program searching technique. Alternatively, the user 101 can access the incentive program by scanning a code at the merchant system 130, following a link on the Internet, or via any other suitable method. The user 101 can select the incentive program and associate the program with the user proxy card account managed by the payment processing system 140.

The user 101 can associate more than one incentive program offered by each merchant system 130 associated with the payment processing account 140. The user 101 can additionally associate incentive programs offered by more than one merchant system 130 associated with the payment processing account 140.

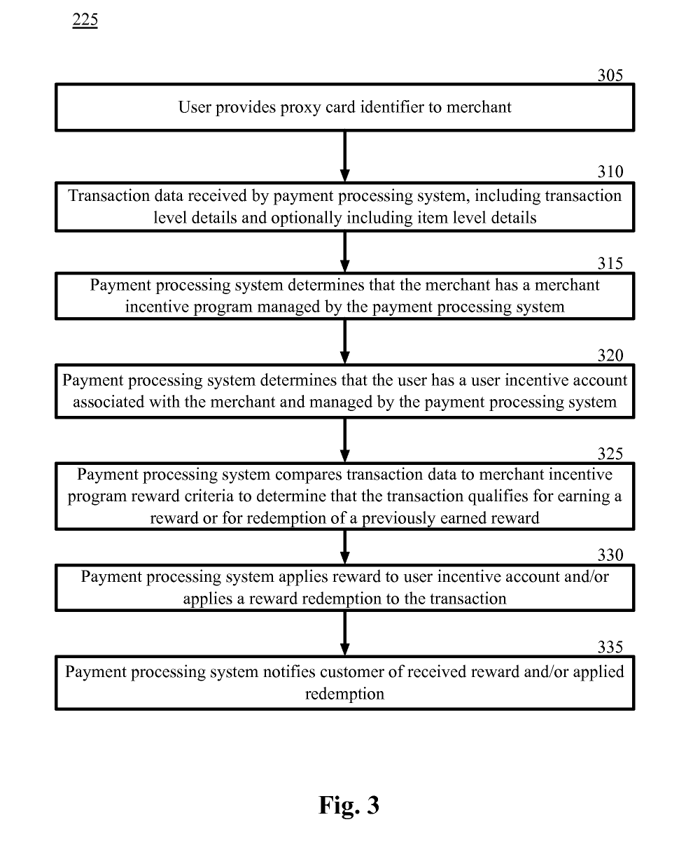

In block 225, the payment processing system 140 accesses the user incentive account when the user 101 conducts a transaction at the merchant system 130 using the proxy card account of the user 101. The details of block 225 are described in method 225 of FIG. 3.

FIG. 3 is a block flow diagram depicting a method 225 to access and update a user incentive account when a user 101 conducts a transaction using a proxy card, in accordance with certain example embodiments.

In block 305, the user 101 selects a product of a merchant system 130 for purchase and presents the proxy card to the merchant system 130. The term “product” can refer to tangible and intangible products as well as services. The user 101 initiates a transaction with the merchant POS terminal 134. The user 101 can “tap” or swipe a user computing device 110 to initiate the communication with the POS terminal 134, actuate a real or virtual button, speak a voice command, or in any suitable manner initiate the transaction. The digital wallet application module 111 on the user computing device 110 can transmit the proxy card identification to the POS terminal 134. Alternatively, the user 101 can employ any other device to initiate the transaction, such as a magnetic stripe card 120, a smartcard, an RFID device, or any other suitable device. In an alternate example embodiment, the transaction is an online transaction and the user 101 can input the proxy card information or employ a digital wallet application module 111 on the user computing device 110.

In block 310, the payment processing system 140 receives the transaction data, including item level details and transaction level details from the merchant system 130. The merchant system 130 transmits the transaction request to the payment processing system 140 via the network 105 or via any suitable network or method. The transaction request includes transaction details such as the total price, included taxes, merchant system 130 identification, the user 101 account identification and any other suitable information and data. The transaction request can optionally include item level details, such as item identification, quantity of items, costs per item, and other suitable item level data. In an alternate embodiment, the item level details are transmitted to the payment processing system 140 in a separate transmission from the merchant system 130, the user computing device 110, or from any suitable computing system. The item level details can be transmitted over the network 105, via email, text, or any suitable communication method.

The merchant system 130 recognizes that a proxy card is being utilized for the transaction and transmits the transaction data to the payment processing system 140. In alternate example embodiments, the merchant system 130 transmits the transaction data to the card network and the card network recognizes that a proxy card is being utilized. The recognition of a proxy card transaction can be made at any point in the transaction or after the transaction, and by any party involved in the transaction process. Alternatively, the parties involved in routing the transaction may view the proxy card payment information as a typical payment method, such as a credit card payment. An identifier in the proxy card payment information instructs the transaction parties to route the proxy card payment information to the payment processing system 140 for processing of the transaction.

In block 315, when the payment processing system 140 receives the transaction data from the merchant system 130, the payment processing system 140 determines if the merchant system 130 has a merchant account on the payment processing system 140 and has established one or more incentive programs. The payment processing system 140 can search a database on the data storage unit 147, other databases, or other storage locations to identify the merchant system 130 and any associated incentive programs based on the data provided with the transaction details. The payment processing system 140 identifies the merchant system 130 identification from the transaction details. The identification may be an identification number, merchant system 130 name, phone number, or any suitable identifying information. The payment processing system 140 searches the database or other records to identify the merchant system 130 account based on the merchant system 130 identifying information. If the merchant system 130 has an account on the payment processing system 140, then the payment processing system 140 can search the account to determine if the merchant system 130 has established one or more incentive programs.

In block 320, if the merchant system 130 has established an incentive program, the payment processing system 140 determines if the user 101 has an account in one or more of the incentive programs associated with the user's proxy card account. The payment processing system 140 can extract the proxy card number of the user 101 and can compare the proxy card number to the database containing the incentive programs. If the proxy card number of the user 101 matches the identification information of a participant in the incentive program of the merchant system 130, then the payment processing system 140 identifies the incentive program as an incentive program in which the user 101 is participating.

In block 325, the payment processing system 140 compares the transaction data to the incentive rules and parameters for the incentive program. The payment processing system 140 determines whether the transaction qualifies for an incentive program configured by the merchant system 130 and joined by the user 101. The payment processing system 140 determines whether the purchases in the transaction meet any requirements for a reward, rebate, or other incentive based on the comparison of the transaction with the incentive program rules. The payment processing system 140 can compare the transaction details and item level details, if available, to the rules and parameters configured for the incentive program. If the transaction details and/or the item level details conform to the rules, then the payment processing system 140 can determine that an incentive is earned. For example, an incentive program may provide a 10% rebate if a user 101 conducts a transaction with the merchant system 140 that exceeds $50. If the transaction details indicate that the transaction request is for a total of $100, then the payment processing system 140 can determine that the incentive is earned.

In block 330, the payment processing system 140 applies an earned incentive or reward to the user incentive account. In an alternate example, the payment processing system 140 applies a reward redemption to the transaction.

In an example embodiment, the incentive program is a loyalty rewards program. In a loyalty rewards program, the payment processing system 140 can determine that one or more of the purchased products, or the entire transaction, meets the requirements to receive a reward, loyalty points, a discount, or any other loyalty incentive. For example, the payment processing system 140 can determine that the user 101 has met the requirements of a “buy 3, get 1 free” incentive. In another example, the payment processing system 140 can determine that the transaction is the tenth transaction by the user 101 during a specified time period and a discount is due for the transaction. In another example, the user 101 has purchased a product in a certain category and thus rewards points are due to the loyalty account of the user 101.

If the payment processing system 140 determines that an incentive is due to the user 101, the payment processing system 140 can identify the incentive that is due based on the rules of the incentive program. For example, if a 10% rebate is due for a qualifying transaction, then the payment processing system 140 provides the rebate based on the rules of the incentive program or a configuration of the user account. The payment processing system 140 can provide the rebate as cash back to an account of the user 101, reduce the transaction amount by 10%, deposit the 10% onto a stored value account of the user 101, or provide the incentive in any suitable manner.

In another example, if the payment processing system 140 determines that a certain quantity of rewards points are earned in a transaction based on the rules of the incentive program, then the payment processing system 140 can deposit the rewards into a loyalty account of the user 101 or provide the loyalty points in any suitable manner.

In another example embodiment, the incentive program is a stored value account. The user 101 has established the stored value account and associated the stored value account with the proxy card account of the user 101. The stored value account contains funds that can be used for transactions at the merchant system 130 associated with the stored value account. The funds can be deposited in the stored value account by the user 101, by the merchant system 130, or any suitable party.

When a user 101 conducts a transaction with the merchant system 130 associated with the stored value account, the payment processing system 140 can use the funds in the stored value account to fund some or all of the transaction. The payment processing system 140 can automatically use the stored value funds, offer to the user 101 an option to use the stored value fund, or follow any other rules or guidelines for using the stored value funds.

Additionally or alternatively, the stored value account can be configured as one of the backing instruments for the proxy card account. The stored value account can be used in any transactions, may be limited to transactions with the merchant system 130 associated with the stored value account, or can be limited according to any suitable set of rules or restrictions.

Additionally or alternatively, the stored value account can receive rewards supplied by the merchant system 130, the payment processing system 140, or any suitable party. For example, if the user 101 is due a reward for a qualifying purchase, the reward can be in the form of funds deposited into the stored value account of the user 101.

The payment processing system 140 can report the use of the incentive program to the merchant system 130 and/or the user 101. For example, the payment processing system 140 can supply a report to the merchant system 130 that indicates the rewards earned by users 101. The report can show individual users 101 or groups of users. The report can categorize users 101 and indicate trends and usage rates for different categories of users 101. The report can indicate the total costs of incentive programs over any period of time. The report can allow the merchant system 130 to better modify the incentive programs to limit costs or produce different results. The report can allow a merchant system 130 to see the activity of a user 101 to determine factors such as frequency of transactions, total value of transactions, date of most recent transaction, and other suitable data. The payment processing system 140 can supply the report to the merchant system 130 or the merchant system 130 can access the data on a server or website of the payment processing system 140. The merchant system 130 can sort and analyze the data from the payment processing system 140 to improve the incentive programs or to better achieve desired goals.

In block 335, the merchant system 130 or the payment processing system 140 can report data detailing the use of the incentive program to the user 101. The data can indicate to the user 101 the reward level attained, usage required to obtain the next reward level, the available funds in the stored value account, transaction history with the merchant system 130, view new incentives available, and other suitable data.

For example the payment processing system 140 can report to the user 101 that the user 101 has conducted a transaction with a merchant system 130 nine times in the current year and that the user 101 will earn an incentive on the tenth transaction with the merchant system 130. The transmission can be an email, text, instant message, or any suitable communication. Additionally or alternatively, the user 101 can access incentive account data on a user interface system of the payment processing system 140. For example, the user 101 can access the user interface system over the Internet and review incentives earned, future incentives, and other suitable data.

In another example, the payment processing system 140 can report to the user 101 the value of a stored value account. The payment processing system 140 can send a report every month, send a report when the stored value account balance changes, or send a report at any suitable time. The report or any suitable notices regarding the stored value account can be transmitted via email, text, instant message, or any suitable communication method.

The user 101 can utilize the incentive program data to better manage future transactions with the merchant system 130 or for any suitable purposes. For example, if the user 101 will earn an additional incentive on the next transaction with a merchant system 130, then the user 101 can use that information to make a better purchasing decision.

Example Systems

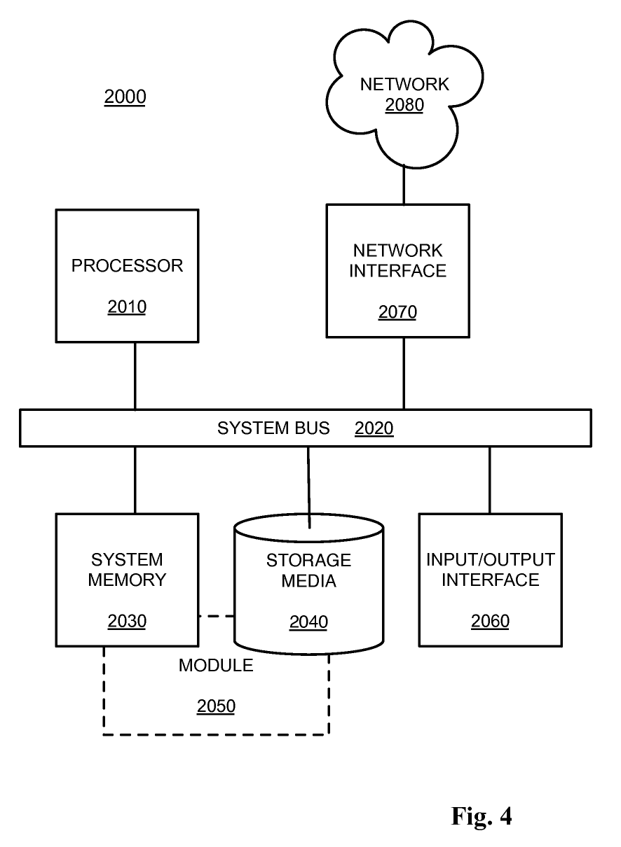

FIG. 4 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, biometric readers, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions claimed herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to maintain incentive programs on proxy card payment processing systems, comprising:
associating, using one or more computing devices, a user proxy card account with a user;
associating, using the one or more computing devices, the proxy card account with a plurality of financial accounts that can be selected for funding financial transactions;
associating, using one or more computing devices, a merchant account with a merchant, the merchant account comprising an incentive program comprising a set of rules for obtaining an incentive in connection with a purchase transaction;
associating, using one or more computing devices, the user proxy card account with the incentive program;
receiving, using one or more computing devices, a payment authorization request comprising transaction data from a merchant computing device operated by the merchant, the transaction data comprising an identification of the user proxy card account for funding of the transaction and information for at least one item involved in a purchase transaction with the merchant;
accessing, using the one or more computing devices, the user proxy card account based on the identification of the user proxy card account received in the transaction data;
determining, using the one or more computing devices, that the user proxy card account is associated with the merchant's incentive program based at least in part on the association between the user proxy card account and the incentive program;
determining, using one or more computing devices, whether the item information in the transaction data meets at least one rule in the set of rules for obtaining the incentive, in response to determining that the user proxy card account is associated with the merchant's incentive program;
when the item information in the transaction data meets at least one rule in the set of rules for obtaining the incentive, applying, using the one or more computing devices, the incentive to the user proxy account associated with the merchant's incentive program; and
communicating, using the one or more computing devices, a notification of the applied incentive to a user associated with the user proxy card account.

2. The computer-implemented method of claim 1, wherein the user proxy card account is associated with a plurality of incentive programs that are each established by one of a corresponding one of a plurality of merchants.

3. The computer-implemented method of claim 1, wherein the incentive program is a loyalty rewards program.

4. The computer-implemented method of claim 1, wherein the incentive program is a stored value account.

5. The computer-implemented method of claim 4, wherein the applied incentive is deposited into the stored value account.

6. The computer-implemented method of claim 4, wherein the stored value account is available as a financial account for a transaction associated with the user proxy card account.

7. The computer-implemented method of claim 1, further comprising:
storing, using the one or more computing devices, applied incentive data from a plurality of applied incentives;
categorizing, using the one or more computing devices, the applied incentive data associated with one or more user proxy card accounts;
determining, using the one or more computing devices, usage data based on an analysis of the stored applied incentive data; and
providing, using one or more computing devices, the usage data from the applied incentives to the merchant computing device.

8. A computer program product, comprising:
a non-transitory computer-readable storage device having computer-executable program instructions embodied thereon that when executed by a computer cause the computer to maintain incentive programs on proxy card payment processing systems, the computer-executable program instructions comprising:
computer-executable program instructions to associate a user proxy card account with a user;
computer-executable program instructions to associate the proxy card account comprising with a plurality of financial accounts that can be selected for funding financial transactions;
computer-executable program instructions to associate a merchant account with a merchant, the merchant account comprising an incentive program comprising a set of rules for obtaining an incentive in connection with a purchase transaction; a selection of a first financial account to be used to fund the transaction;
computer-executable program instructions to associate the user proxy card account with the incentive program;
computer-executable program instructions to provide an authorization to the merchant for the transaction;
computer-executable program instructions to receive a payment authorization request comprising transaction data from a merchant computing device operated by the merchant, the transaction data comprising an identification of the user proxy card account for funding of the transaction and information for at least one item involved in a purchase transaction with the merchant;
computer-executable program instructions to access the user proxy card account based on the identification of the user proxy card account received in the transaction data;
computer-executable program instructions to determine that the user proxy card account is associated with the merchant's incentive program based at least in part on the association between the user proxy card account and the incentive program;
computer-executable program instructions to determine whether the item information in the transaction data meets at least one rule in the set of rules for obtaining the incentive, in response to determining that the user proxy card account is associated with the merchant's incentive program;
computer-executable program instructions to apply the incentive to the user proxy account associated with the merchant's incentive program when the item information in the transaction data meets at least one rule in the set of rules for obtaining the incentive; and
computer-executable program instructions to communicate a notification of the applied incentive to a user associated with the user proxy card account.

9. The computer program product of claim 8, further comprising:
computer-executable program instructions to store applied incentive data from a plurality of applied incentives;
computer-executable program instructions to categorize the applied incentive data associated with one or more user proxy card accounts;
computer-executable program instructions to determine usage data based on an analysis of the stored applied incentive data; and
computer-executable program instructions to provide the usage data from the applied incentives to the merchant computing device.

10. The computer program product of claim 8, wherein the user proxy card account is associated with a plurality of incentive programs that are each established by one of a corresponding one of a plurality of merchants.

11. The computer program product of claim 8, wherein the incentive program is a loyalty rewards program.

12. The computer program product of claim 8, wherein the incentive program is a stored value account.

13. The computer program product of claim 13, wherein the applied incentive is deposited into the stored value account.

14. The computer program product of claim 13, wherein the stored value account is available as a financial account for a transaction associated with the user proxy card account.

15. A system to select an alternate payment instrument after a proxy card payment transaction, the system comprising:
a storage resource;
a network module; and
a processor communicatively coupled to the storage resource and the network module, wherein the processor executes application code instructions that are stored in the storage resource and that cause the system to:
associate a user proxy card account with a user;
associate the proxy card account comprising with a plurality of financial accounts that can be selected for funding financial transactions;
associate a merchant account with a merchant, the merchant account comprising an incentive program comprising a set of rules for obtaining an incentive in connection with a purchase transaction; a selection of a first financial account to be used to fund the transaction;
associate the user proxy card account with the incentive program;
provide an authorization to the merchant for the transaction;
receive a payment authorization request comprising transaction data from a merchant computing device operated by the merchant, the transaction data comprising an identification of the user proxy card account for funding of the transaction and information for at least one item involved in a purchase transaction with the merchant;
access the user proxy card account based on the identification of the user proxy card account received in the transaction data;
determine that the user proxy card account is associated with the merchant's incentive program based at least in part on the association between the user proxy card account and the incentive program;
determine whether the item information in the transaction data meets at least one rule in the set of rules for obtaining the incentive, in response to determining that the user proxy card account is associated with the merchant's incentive program;
when the item information in the transaction data meets at least one rule in the set of rules for obtaining the incentive, apply the incentive to the user proxy account associated with the merchant's incentive program; and
communicate a notification of the applied incentive to a user associated with the user proxy card account.

16. The system of claim 15, the processor executing further application code instructions that are stored in the storage device and that cause the system to:
store applied incentive data from a plurality of applied incentives;
categorize the applied incentive data associated with one or more user proxy card accounts;
determine usage data based on an analysis of the stored applied incentive data; and
provide the usage data from the applied incentives to the merchant computing device.

17. The system of claim 15, wherein the user proxy card account is associated with a plurality of incentive programs that are each established by one of a corresponding one of a plurality of merchants.

18. The system of claim 15, wherein the incentive program is a loyalty rewards program.

19. The system of claim 15, wherein the incentive program is a stored value account.

20. The system of claim 19, wherein the stored value account is available as a financial account for a transaction associated with the user proxy card account.
